(19) United States
(12) Patent Application Publication
(10) Pub. No.: US 2013/0238779 A1
(43) Pub. Date: Sep. 12, 2013

(54) DATA STRUCTURE FOR MANAGING SENSOR NETWORK USING ID OF SENSOR NODE AND METHOD USING THE SAME

(71) Applicant: Electronics and Telecommunications Research Institute, (US)

(72) Inventors: Yong-Woon KIM, Chungcheongnam-do (KR); Jun-Seob LEE, Daejeon-city (KR); Sang-Keun YOO, Chungcheongnam-do (KR); Byoung-Nam LEE, Daejeon-city (KR); Hyoung-Jun KIM, Daejeon-city (KR)

(73) Assignee: Electronics and Telecommunications Research Institute, Daejeon-city (KR)

(21) Appl. No.: 13/873,577

(22) Filed: Apr. 30, 2013

Related U.S. Application Data
(62) Division of application No. 12/306,829, filed on Dec. 29, 2008.

(30) Foreign Application Priority Data
Jun. 29, 2006 (KR) 10-2006-0059365
Dec. 5, 2006 (KR) 10-2006-0122615

(51) Int. Cl. H04L 12/24

(52) U.S. Cl. CPC H04L 41/00
USPC 709/223

(57) ABSTRACT

A sensor node address management data structure and a method of managing a sensor network using an identifier of a sensor node can provide a single management system based on ID information used to identify the sensor node even though a sensor network management system does not provide a plurality of management systems based on an individual identification system for sensor networks and sensor nodes that are to be built in a variety of network environments. The sensor node address management data structure that is managed by a network management system for managing a sensor network includes: a first field including an identifier allocated to a sensor node; a second field indicating a network management type of the sensor node to make a connection to the sensor network; and a third field providing address information on the sensor node necessary for the connection to the sensor network.

### RELATED APPLICATIONS

This application is a divisional application of U.S. patent application Ser. No. 12/306,829 filed on Dec. 29, 2008, which is a 35 U.S.C. §371 national stage filing of PCT Application No. PCT/KR2006/005310 filed on Dec. 08, 2006, which claims priority to, and the benefit of, Korean Patent Application No. 10-2006-0059365 filed on Jun. 29, 2006 and Korean Patent Application No. 10-2006-0122615 filed on Dec. 5, 2006. The contents of the aforementioned applications are hereby incorporated by reference.

### BACKGROUND

An embodiment of the present invention relates to a database structure built in a network management system for managing a sensor network and a method of managing the sensor network, and more particularly, to a database structure providing a single management system regardless of an Internet protocol (IP) or a non-IP lower network by building an identifier-based management system although a sensor network management system does not support the IP and non-IP based sensor networks in order to manage both IP and non-IP based sensor networks, and a sensor network management method.

A simple network management protocol (SNMP) is generally used to manage a variety of network devices in an IP communication network. The SNMP, which is independent of an IP, can be used in both IP and non-IP communication networks.

It has become very important to develop a communication protocol for reducing power consumption in a sensor network. The SNMP has a large communication packet size so that a network management protocol can be newly developed in order to reduce power consumption.

Therefore, the SNMP may be used as the network management protocol in an IP-based sensor network in order to utilize an existing network management system, or a new low power sensor network management protocol may be developed and used.

Most sensor networks are assumed to be non-IP based sensor networks, in which the IP independent SNMP or the new low power sensor network management protocol may be used.

No matter what type of sensor network management protocol is used, a management object must be identified in order to perform a network management function, which is settled via identification means. In more detail, a corresponding object must be designated in order to check the current status of a specific management element of a specific target system, thereby requesting the current status of a target object.

Since all network devices are located in the same IP network environment, an IP address enables the identification of an individual system and designation of the target system. Thereafter, many management objects included in a system must be designated using an object identifier (OID), which is another identification means. In more detail, a specific management function can be performed with regard to any management objects in the IP network environment by merely designating an IP address of a sensor node and an OID of a management object. A network management system in an IP network performs a remote management function with regard to all management objects using the IP address and the OID.

On the other hand, each sensor node in a non-IP network environment does not have an IP address but uses a network address according to its own networking system, and has a unique address that is identified in the same communication network. Therefore, a network management system of a non-IP sensor network must be dedicated to the non-IP network environment.

However, a management institution requires that the network management system of the non-IP sensor network is not built in a non-IP sensor network area far away from an administrator but in a management institution including IP based networks. In more detail, a sensor network management system must be built in an IP network of the management institution irrespective of an IP based sensor network or a non-IP based sensor network. Therefore, the sensor network management system can make it possible to remotely manage the IP based sensor network belonging to the same IP network, and the non-IP based sensor network that is remotely located via the IP network.

However, since methods of identifying IP and non-IP based sensor networks are different from each other, the sensor network management system of the management institution must unite two management functions supporting two identification systems in a system in order to perform a desired network management function. This makes the management more complex, causes management errors due to a unity of two different management systems, and increases management costs.

### SUMMARY

An embodiment of the present invention provides a sensor network management method by building an ID based management system in order to remotely manage IP and non-IP based sensor networks, even though a sensor network management system does not support both IP and non-IP based sensor networks, thereby operating a single management system irrespective of an IP or non-IP lower network, and a database used for the same.

According to an aspect of the present invention, there is provided a sensor node address management data structure that is managed by a network management system for managing a sensor network comprising: a first field including an identifier allocated to a sensor node; a second field indicating a network management type of the sensor node to make a connection to the sensor network; and a third field providing address information on the sensor node necessary for the connection to the sensor network.

According to another aspect of the present invention, there is provided a method of accessing a sensor node and obtaining information on a management object by a sensor network management system, the method comprising: building a database including addresses of sensor nodes managed by the sensor network management system based on identifiers allocated to the sensor nodes; receiving an identifier of the sensor node whose information is to be obtained; obtaining information corresponding to the identifier of the sensor node from the database and then sending a management function message to the sensor node; and receiving state information corresponding to the management function message.

The sensor node address management data structure and a method of managing a sensor network using an identifier of a sensor node can provide a single management system based on ID information used to identify the sensor node although a sensor network management system does not provide a plurality of management systems based on an individual identification system for sensor networks and sensor nodes that are to be built in a variety of network environments. In more detail, no matter if the sensor node has an IP address or not or what the network conditions are, the single management system can identify the sensor node using an identifier of the sensor node, and a network management protocol communication can be substantially performed by a mutual operation of a sensor network management system, a network management relay agent, and a network management agent.

The single sensor network management system reduces a management load of an administrator, a possibility of occurrence of an error owing to a less complex management system, and management costs since the building, maintenance, and management of only the single management system are necessary.

### BRIEF DESCRIPTION OF THE DRAWINGS

The above and other features and advantages of the present invention will become more apparent by describing in detail exemplary embodiments thereof with reference to the attached drawings in which:

FIG. 1 is a table illustrating a sensor node address management data structure for managing a sensor network using a sensor node identifier according to an embodiment of the present invention;

FIG. 2 is a flowchart of a method of managing a sensor network using a sensor node identifier according to an embodiment of the present invention; and

FIGS. 3 and 4 are detailed flowcharts illustrating a method of managing a sensor network using a sensor node identifier according to an embodiment of the present invention.

### DETAILED DESCRIPTION

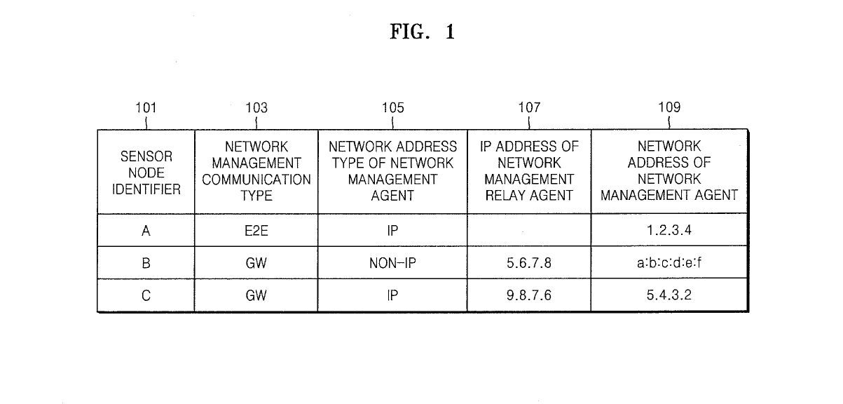

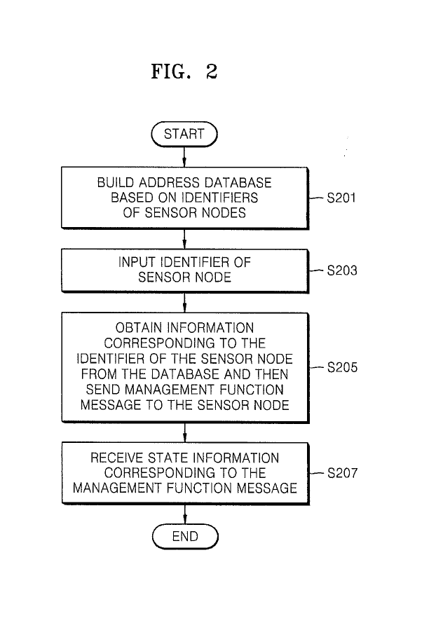

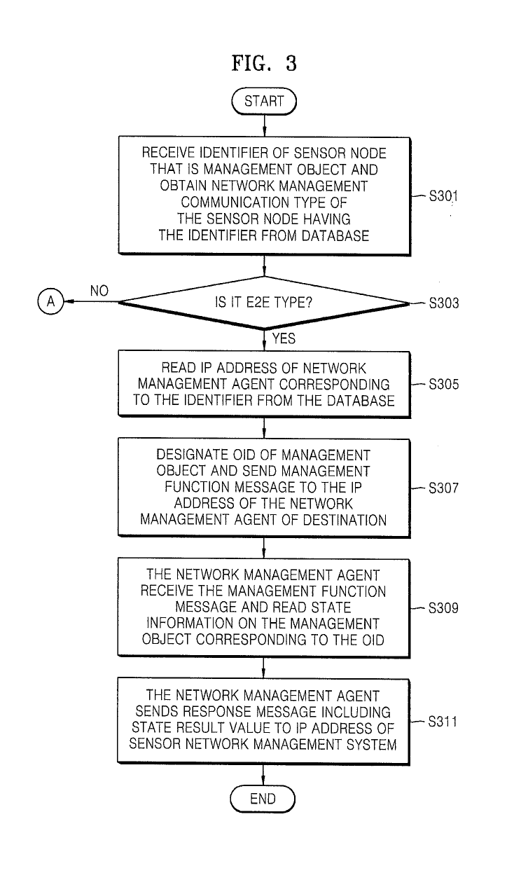

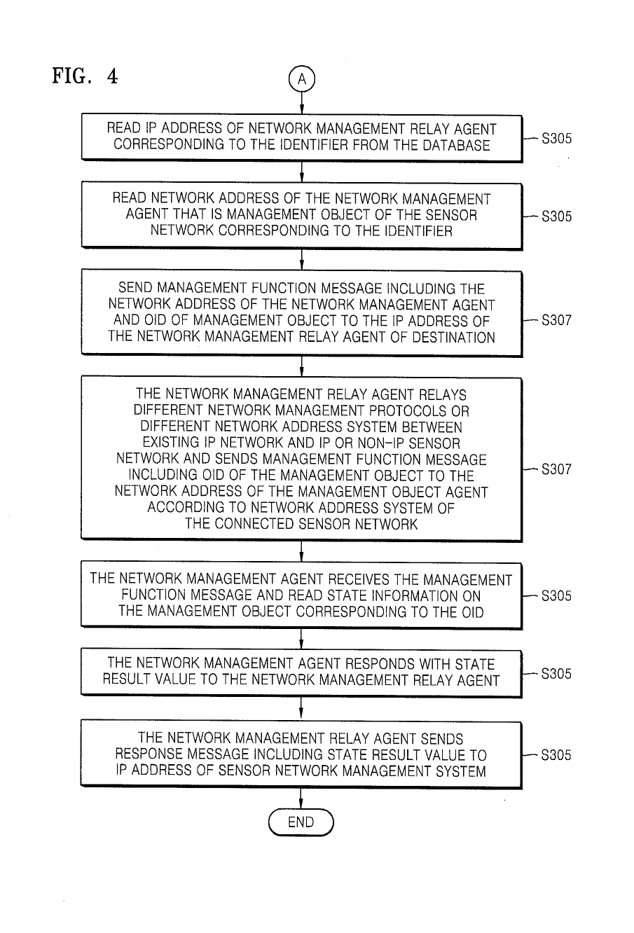

Embodiments of the present invention will now be described more fully with reference to the accompanying drawings. FIG. 1 is a table illustrating a sensor node address management data structure for managing a sensor network using a sensor node identifier according to an embodiment of the present invention. FIG. 2 is a flowchart of a method of managing a sensor network using a sensor node identifier according to an embodiment of the present invention. FIGS. 3 and 4 are detailed flowcharts illustrating a method of managing a sensor network using the sensor node identifier of FIG. 2 according to an embodiment of the present invention.

A network management system necessarily requires identification means of a management object in order to specify a final management object and perform a management function, and, if a sensor network includes all IP based sensor nodes, the network management system needs an IP address only for identifying a node in a network and object identifiers (OIDs) used to identify various types of management objects in the node.

However, since most sensor networks are non-IP based, the IP address and OIDs make it impossible to manage all IP and non-IP sensor network nodes. In more detail, since there are two identification systems for sensor nodes in an IP network and a non-IP network, the IP address and OIDs, which are used to identify sensor nodes in the IP network, make it impossible to manage all non-IP sensor network nodes.

In order to overcome this problem, an embodiment of the present invention identifies sensor nodes based on sensor node IDs in a higher hierarchical manner. In more detail, a sensor network management system solely identifies an IP based sensor node or a non-IP based sensor node based on IDs which comprise a single identification system. Thus, the sensor network management system can build, maintain, and manage a single management system even though various types of sensor nodes are installed in various types of a lower network.

Substantial network communication is supported to build an ID based sensor network management system. Thus, a network communication relationship is defined according to the type of lower network in order to realize a management function. An embodiment of the present invention establishes such a network communication relationship.

A method of managing a sensor node will now be described with reference to the accompanying drawings. A sensor network management system builds the sensor node address database having the constitution illustrated in FIG. 1 (Operation S201). The network management relay agent shown in FIG. 1 is an application program that is installed in a gateway system in which an IP or non-IP based sensor network is connected to an IP network, and relays a sensor network management function between the sensor network and the IP network. A network management agent is an application program that is installed in an IP based sensor node or a sensor node of a non-IP based sensor network and performs the management function. The sensor node is a sole physical entity existing in a network, and thus has a sole network address that may be an IP address or a medium access protocol (MAC) network address such as a wireless regional area network (WRAN), Bluetooth, IEEE 802.15.4 or the like. Meanwhile, one sensor node may have a plurality of application programs. A relay agent or agent is one of these application programs. Therefore, it is necessary to identify the plurality of application programs included in one sensor node in dependent of an operating system of the sensor node or a protocol communication system. Thus, the identification of application programs is beyond the scope of the present invention. For reference, an application program that uses transmission control protocol/Internet protocol (TCP/IP) network communication is identified through a port number of a TCP or user datagram protocol (UDP).

An administrator inputs an ID of the sensor node that is a management object and an OID of the management object in the sensor network management system, and requests notification of a current state of the management object (Operation S203). A network management protocol communication message relating to the management function must be transmitted to the sensor node through the IP network. The network management protocol may be a simple network management protocol (SNMP), a newly developed low power protocol, or a combination of the SNMP and the low power protocol depending on a communication section.

The administrator requests the sensor network management system for confirmation on the current state of the sensor node. The sensor network management system reads information necessary for the communication from the management information database thereof, and operates in various ways according to a sensor network management communication method and whether the sensor node is IP or non-IP based. Such various operations are just an internal function of the sensor network management system, which operates under the single ID management system. Therefore, the sensor network management system transmits the management function message to the sensor node (Operation S205), and receives state information in response to the management function message (Operation S207).

For example, if the administrator inputs an ID 101 of a sensor node “A” and an OID of a management object “1”, the sensor network management system reads management information on the sensor node “A” from the management information database shown in FIG. 1. The sensor network management system determines whether end-to-end (E2E) or gateway GW is used to manage the sensor node as a network management tool based on the information provided by a network management communication system field 103 (Operations S301 and S302). The E2E network management tool needs no network management relay agent since the same network address system is used between the sensor network management system and the sensor node in a remote sensor network no matter what protocol is selected from among the SNMP, a common management interface protocol (CMIP), a remote monitoring (RMON) protocol, an existing network management protocol, or a new network management protocol between both networks. Meanwhile, the GW network management tool needs a network management relay agent since both networks use a different network management protocol. Although both networks use the same network management protocol, since different IP and non-IP network address systems require a relay function between both networks. The E2E and GW network management tools and the IP and non-IP network address systems can be explicitly divided as shown in FIG. 1 or implicitly divided using other methods. Therefore, the method of dividing them is beyond the scope of the present invention.

If the sensor node uses the E2E network management tool, the sensor network management system reads an IP address of the sensor node from the database shown in FIG. 1 (Operation S305). The IP address of the sensor node is an IP address 109 of the network management agent installed in the sensor node. Thus, the sensor network management system is informed of a destination address of a counterpart with which network communication is performed. The sensor network management system sends the management protocol message including the OID information on the management object to the destination IP address (Operation S307). The sensor node in the destination transmits the received management protocol message to the network management agent, the network management agent identifies the management object using the OID information, and reads the state information on the management object (Operation S309). The network management agent sends a response message including the state information on the management object to the sensor network management system (Operation S311), indicating that a specific management operation is completed.

For example, the administrator inputs an ID of a sensor node “B” and the OID of the management object “1”, the sensor network management system reads management information on the sensor node “B” from the management information database shown in FIG. 1. In operations S301 and S302, the sensor network management system determines whether E2E or GW is used to manage the sensor node as the network management tool based on the information.

If the sensor node uses the GW network management tool, the sensor network management system reads an IP address of the network management relay agent installed in a gateway device between an existing IP network and the sensor network from the database shown in FIG. 1 (Operation S313). Since the network management relay agent is installed in the gateway device, the IP address of the network management relay agent is a network address of the gateway device that connects a non-IP sensor network and the IP network. Thus, the sensor network management system installed in the IP network is informed of a destination address of that with which network communication is performed.

Thereafter, since the sensor node is under the GW network management, the sensor network management system reads the network address of the sensor node in which the management object agent is installed from the management information database. The network address of the sensor node can be an IP address or a MAC network address.

Next, the sensor network management system sends the management protocol message including the network address of the sensor node and the OID information on the management object to the IP address of the network management relay agent obtained in operation S313 (Operation S317).

A gateway system that relays the existing IP network and the IP or non-IP sensor network receives the management protocol message and sends it to the network management relay agent installed therein. The network management relay agent converts the network management protocol message if a different network management protocol is used between both networks, and receives the network address of the management object agent from the management protocol message and sends the management protocol message to the network address of the management object agent if different IP and non-IP network address systems are used between both networks (Operation S319).

The sensor node in the destination receives the management protocol message and sends it to the network management agent, and the network management agent identifies the management object using the OID information, and reads the state information on the management object (Operation S321).

The network management agent sends a response message including the state information on the management object to the network management relay agent (Operation S323).

The network management relay agent sends the response message including a result value to the sensor network management system that first requests the result value through the IP network (Operation S325).

As another example, the administrator inputs an ID of a sensor node “C” and the OID of the management object “1”, although the sensor network management system operates in the same manner as the administrator inputs the ID of the sensor node “B”, since the sensor network and the network management system network use the same IP network address system, both networks have a different network management protocol. Therefore, a process of converting the network management protocol message starting from operation S319 is only performed in the network management relay agent, and a process of converting a network address system is not performed but a process of sending the converted network management protocol message to the network management agent for the destination of the IP address of the sensor node is performed.

The above three examples describe three methods according to embodiments of the present invention that build and manage a single management system using identifiers of all sensor nodes irrespective of a networking type of a sensor network. However, the present invention is not limited thereto. Details of the three methods can be changed according to the development and realization of the present invention, and the management information database can select a larger number of constituents, and thus all embodiments of the present invention cannot be illustrated.

According to an embodiment of the present invention, when a combination of IP or non-IP based sensor networks is formed in a wired communication network environment such as Ethernet, serial communication, etc. or in a wireless communication network environment such as Bluetooth, ZigBee, Ultra Wideband (UWB), WRAN, etc., the sensor network management system does not build a different management system according to each network environment but allocates an identifier to each sensor node and builds the single management system.

Furthermore, an embodiment of the present invention provides the constitution of the sensor network management system, the network management relay agent, and the network management agent to accommodate IP and various non-IP network environments based on the ID based single management system, the definition of a core operation of each of them, and a method of building the management information database supporting the operation.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, code and code segments for accomplishing an embodiment of the present invention can be easily construed by programmers of ordinary skill in the art to which the present invention pertains.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

1. A method of relaying between a sensor network management system and a sensor network by a network management relay agent, comprising:
receiving a management protocol message including a sensor node information of a sensor node belonging to the sensor network and OID information on a management object of the sensor node from the sensor network management system;
converting the management protocol message to a sensor network protocol message;
delivering the sensor network protocol message to the sensor node based upon the sensor node information;
receiving a response message to the sensor network protocol message from the sensor node; and
sending the response message to the sensor network management system.

2. The method of claim 1, wherein a network between the network management relay agent and the sensor network management system is an IP based network.

3. The method of claim 1, wherein a network between the network management relay agent and the sensor node is a non-IP-based network.

4. The method of claim 1, wherein the sensor network is an IP based network and the sensor node information comprises IP address of the sensor node.
